(19) United States
(12) Patent Application Publication
(10) Pub. No.: US 2011/0113150 A1
(43) Pub. Date: May 12, 2011

(54) METHOD OF TRACKING AND REPORTING USER BEHAVIOR UTILIZING A COMPUTERIZED SYSTEM

(75) Inventors: Michael Nunnery, Bloomfield Hills, MI (US); Charles McGinnis, Holly, MI (US)

(73) Assignee: ABUNDANCE STUDIOS LLC, Birmingham, MI (US)

(21) Appl. No.: 12/943,817

(22) Filed: Nov. 10, 2010

Related U.S. Application Data
(60) Provisional application No. 61/259,671, filed on Nov. 10, 2009.

(51) Int. Cl. G06F 15/16; G06F 21/00

(52) U.S. Cl. 709/231; 726/4

(57) ABSTRACT

A computerized system utilizes a method of tracking and reporting user behavior. The system includes a server computer, a first client computer, and a second client computer. The method includes the steps of identifying a first user and offering a trackable asset to the first user, wherein the trackable asset is receivable by the first user. A request to receive the trackable asset is received by the server computer. The method determines a type of asset that is requested and then authenticates whether or not the first user is authorized to receive the trackable asset. The method continues with the step of delivering the trackable asset to the first user if the first user is authorized to receive the trackable asset. Data regarding delivery of the trackable asset to the first user is recorded. The method further includes the step of reporting the data to a second user.

### CROSS REFERENCE TO RELATED APPLICATION

This application claims the benefit of provisional patent application No. 61/259,671 filed Nov. 10, 2009, which is hereby incorporated by reference.

### BACKGROUND OF THE INVENTION

1. Field of the Invention

The invention relates generally to computerized systems and methods for tracking data delivered to a user. Particularly, the invention relates to tracking sales and marketing information delivered to the user.

2. Description of the Related Art

Recently, the delivery of sales and marketing information is often taking place via computerized systems. These systems allow an individual to watch training videos, listen to lectures, motivational speeches, or sales/marketing information, and perform other associated tasks via a personal computer or other electronic device.

Unfortunately for managers, supervisors, and other sales and marketing staff, it is difficult to appreciate exactly what training has been accomplished by one or more individuals. It is even more difficult to fully comprehend the behavior of the individuals when interacting with such videos, audio lectures, etc. As such, there remains an opportunity for a computerized system and method for tracking and reporting on user behavior.

### BRIEF SUMMARY

The subject application discloses a method of tracking and reporting user behavior on a computerized system. The computerized system may include a server computer, a first client computer, and a second client computer. The method includes the steps of identifying a first user and offering a trackable asset to the first user, wherein the trackable asset is receivable by the first user. A request to receive the trackable asset is received by the server computer. The method determines a type of asset that is requested and then authenticates whether or not the first user is authorized to receive the trackable asset. The method continues with the step of delivering the trackable asset to the first user if the first user is authorized to receive the trackable asset. Data regarding delivery of the trackable asset to the first user is recorded. The method further includes the step of reporting the data to a second user.

By tracking and reporting the behavioral data of the first user to the second user, the system and method enable the second user to quickly and intelligently react to the assets being received by the first user. This allows the second user to contact and counsel the first user based on the assets that have been downloaded.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block schematic diagram of one embodiment of a computerized system for tracking and reporting user behavior including a server computer, a first client computer, and a second client computer;

FIG. 2 is a flowchart of one embodiment of a method utilizing the computerized system detailing discovery of trackable assets by an unknown first user;

FIG. 3 is a flowchart of one embodiment of the method utilizing the computerized system detailing discovery of trackable assets by a known first user;

FIG. 4 is a flowchart of one embodiment of the method utilizing the computerized system detailing request of a trackable asset by the unknown first user;

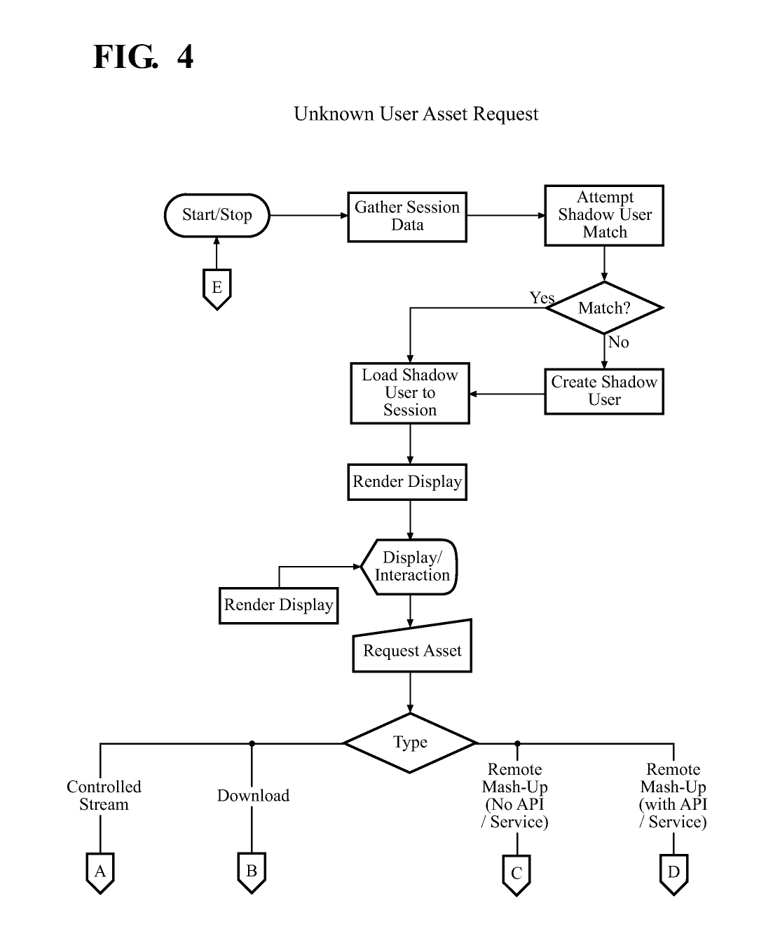

FIG. 5 is a flowchart of one embodiment of the method utilizing the computerized system detailing request of a trackable asset by the known first user;

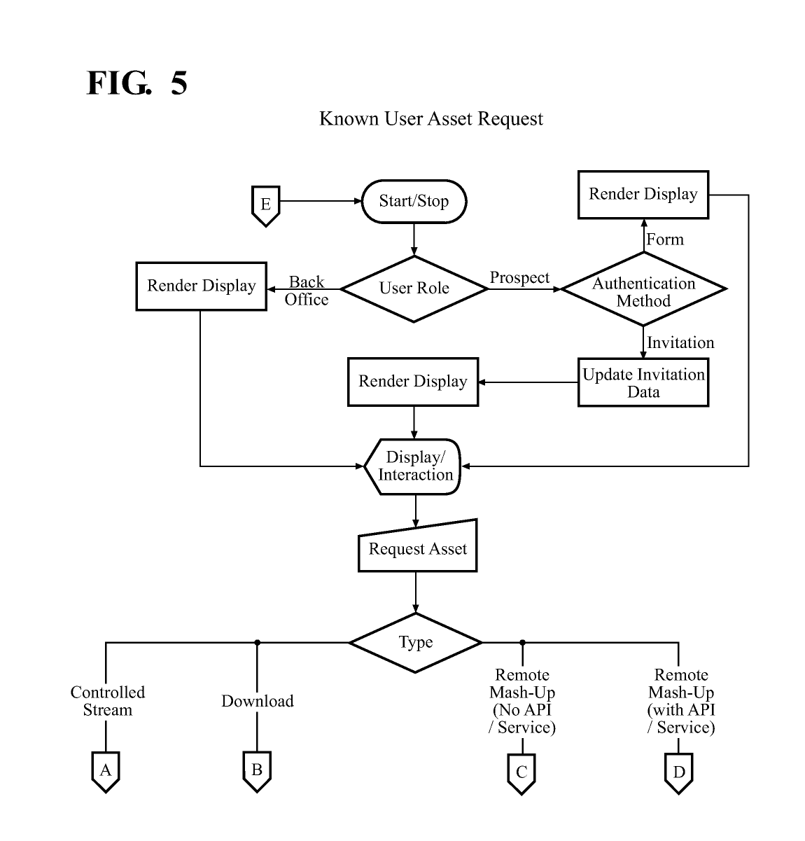

FIG. 6 is a flowchart of one embodiment of the method utilizing the computerized system detailing tracking of a controlled stream to the first user;

FIG. 7 is a flowchart of one embodiment of the method utilizing the computerized system detailing tracking of a downloadable file to the first user;

FIG. 8 is a flowchart of one embodiment of the method utilizing the computerized system detailing tracking of a remote mash-up with no API or services to the first user;

FIG. 9 is a flowchart of one embodiment of the method utilizing the computerized system detailing tracking of a remote mash-up with an API or services to the first user; and

FIG. 10 is a graphical representation of a window displayable on the second client computer to show various tracking results by a plurality of first users.

### DETAILED DESCRIPTION

Referring to the Figures, wherein like numerals indicate like parts throughout the several views, a computerized system 10 and method of tracking and reporting user behavior is shown and described herein.

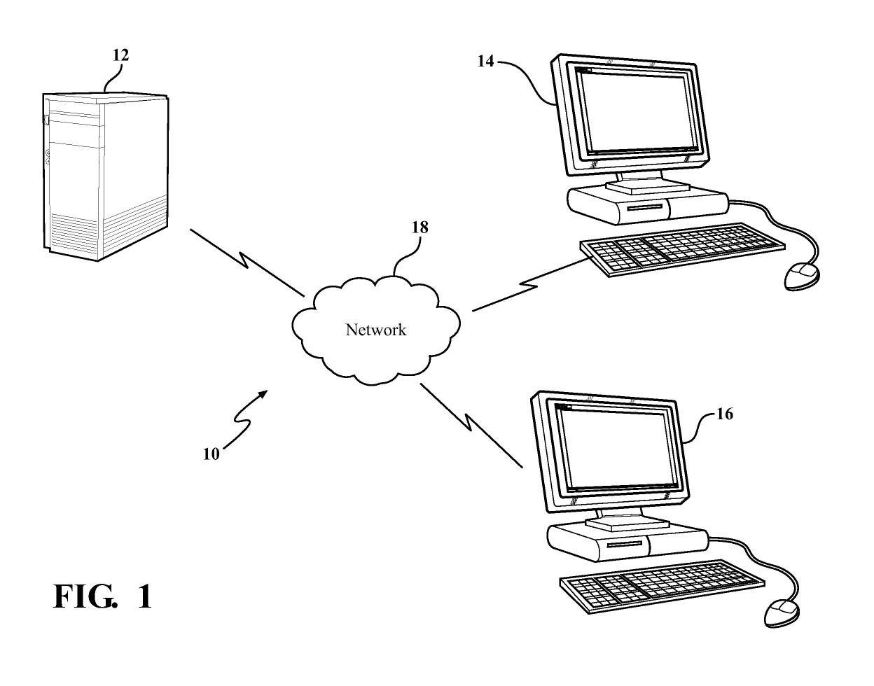

Referring to FIG. 1, the computerized system 10 includes a server computer 12, a first client computer 14, and a second client computer 16. For illustrative purposes, the computers 12, 14, 16 are shown in FIG. 1 as three separate, distinct, and conventional devices having at least one microprocessor for running software applications. However, it is to be understood that the computers 12, 14, 16 may be implemented as less than three separate and distinct devices. For instance, the server computer 12 and the second client computer 16 may be the same device. Furthermore, any or all of the computers 12, 14, 16 maybe implemented as non-conventional devices, including, but not limited to, smartphones, personal digital assistants (PDAs), netbooks, televisions, and electronic book readers. It should also be understood that each of the computers 12, 14, 16 may each be virtual devices or terminals, e.g., for use in “cloud computing”. Moreover, the computerized system 10 may support multiple first client computers 14 and multiple second client computers 16. As such, any reference to a single first client computer 14 and a single second client computer 16 should not be read as limiting the number of client computers 14, 16.

The computers 12, 14, 16 are in communication with one another. In the exemplary embodiment presented in FIG. 1, each of the computers 12, 14, 16 is in communication with a network 18. The network 18 may be the global interconnection of computing devices known as the Internet, or another telecommunication network as well known to those skilled in the art. The network 18 may utilize electrically conductive wires, fiber optics, wireless signals (radio frequency, infrared, etc.), and any other technique known to those skilled in the art.

The system 10 executes software to implement the method. That is, the software runs, or operates, on one or more of the computers 12, 14, 16. The software and the method track assets (not numbered) delivered to a first user (not numbered). The first user is a person utilizing the first client computer 14 to access one or more of the assets. The first user may access the assets via a web browser on the first client computer 14. However, other software applications and other techniques may alternatively be utilized to access the assets, as is readily appreciated by those skilled in the art.

In some embodiments, the first user may be referred to as a “prospect”. Of course, the use of the term “first user” should not be interpreted to convey that only one first user, or prospect, may be implemented using the system 10 and associated method. In fact, the system 10 supports multiple first users. Moreover, some first users may actually be subsets of another first user.

The term “asset” as used herein refers to any technological implementation for delivering information, or data, to the first user. More specifically, in the illustrated embodiments, the asset is training information prepared to train the first user with sales and/or marketing techniques. Even more specifically, the asset may be information for facilitating the relationship building between a salesperson and a prospect. A format of each asset may include, but is not limited to: audio, video, text, application functionality, files, text files, or mash-ups. As one example, the asset may be a video stream presenting an instructional video. As another example, the asset may be a portable document format (“pdf”) file providing some information. Those skilled in the art will realize numerous other formats and implementations of an asset in accordance with the subject invention.

The asset may be known to the system 10 (a “known asset”) or unknown to the system (an “unknown asset”). Known assets are those assets that have been registered, or recorded, with the system 10 prior to being sent, i.e., downloaded, to the first user. Conversely, unknown assets are those assets that have not been registered with the system 10.

The method of tracking and reporting user behavior begins with identifying the first user. Several techniques may be utilized to identify the first user. In one technique, the first user “logs in” to the system 10, e.g., by providing a username and password. In another technique, the system 10 identifies the first user based on a uniform resource locator (URL), i.e., a web address, used to access the system 10. Specifically, unique URLs may be sent to a plurality of individuals, such that the unique URL identifies the first user. In the above techniques, the first user may be referred to as a known user, since some actual information regarding the individual is known. In another technique, the first user may be anonymous, i.e., an unknown user. However, the first user may be identified based on IP address, MAC address, or similar information that is commonly provided over the network 18. In such instances, the system 10 may create a shadow user account to track the unknown user.

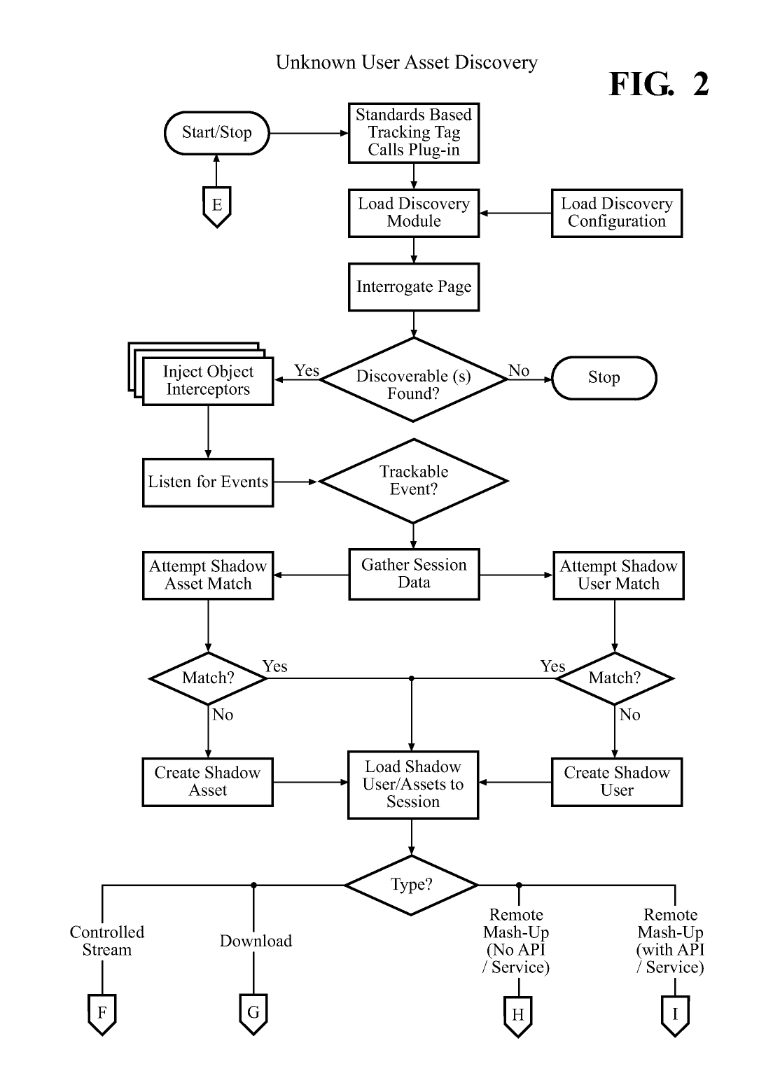

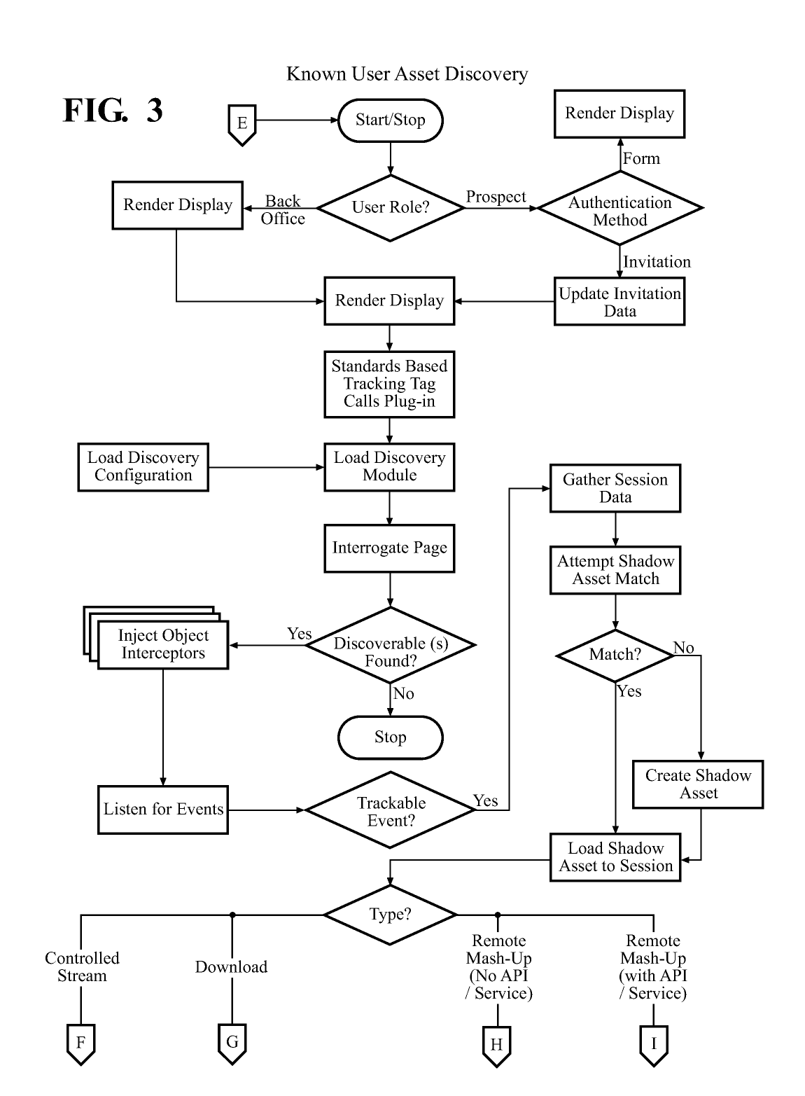

The method may include discovery of one or more trackable assets, as is shown on FIGS. 2 and 3. This discovery is done on web pages that are not known to the system 10. The web page requires an open source, standards compliant tag (not shown), such as a jsHub tag which provides an entry mechanism for certain applications to interrogate the web page. The tag has a plug-in mechanism which allows the system 10 to interact with the page. The system 10 sends and receives calls back and forth to the web page looking for identifiers of items that could be assets. For example, the identifiers may include HTML tags such as <video>, <object>, and <embed> or other meta-data. The system 10 then processes these calls and identifiers to determine if there are any potential assets. Once potential assets are identified, the system 10 adds code to intercept and bifurcate events and session data relative to the potential asset. As such, the system 10 identifies the beginning and ending of trackable events without interfering with normal operation of the web page. The system 10 then attempts to detect a trackable event which would be relevant to a particular asset type. Examples include when a video begins to play, when a mouse rolls over a pdf viewer, or a viewer is launched. If a trackable event occurs, the system 10 then correlates all available data about that potential asset to an existing asset. If a close match is found, then the tracking data is assigned relative to the closely matching asset. Otherwise, a new shadow asset is created.

The method continues by offering one or more trackable assets to the first user, where the trackable assets are receivable by the first user. The offer is preferably presented on the first client computer 14 utilized by the first user. For example, the first user may be presented with a web page presenting a hyperlink stating, “Click HERE for exclusive, proven sales techniques for your business,” or “Listen to this podcast detailing the latest product updates.” Alternatively, the offer of the trackable asset may be a video player window itself, instead of a hyperlink. Those skilled in the art will realize alternative techniques for offering the trackable asset(s) to the user, other than those recited above.

The method further includes the step of receiving a request to receive the trackable asset. In the illustrated embodiments, this request is received by the server computer 12 of the system 10. In one embodiment, the request to receive the trackable asset may be made based on an affirmative selection by the first user using the first client computer 14. In another embodiment, the request to receive the trackable asset may occur automatically, e.g., when a certain web page is accessed. For instance, such an automatic asset request could be a welcome message that plays whether or not specifically requested by the first user.

After the request to receive the trackable asset is received, a type of asset that is requested is determined. As stated above, the multiple asset types having multiple formats may be delivered and tracked by the system 10. In the illustrated embodiment, the server 12 performs this step. However, in other embodiments, the first client computer 14 may determine which type of asset is requested.

Certain assets may not be available to the first user, based on any number of factors. These factors may include, but are not limited to, the role of the first user and the assets previously accessed by the first user. Clearly, these factors may vary depending on the environment in which the system 10 is implemented. For example, in a sales environment, certain assets may not be available if the first user is a new (i.e., novice) sales person.

Accordingly, the method may include the step of authenticating whether or not the first user is authorized to receive the trackable asset. Whether or not the first user is authorized may be manually set, e.g., by another user of the system 10, or may be automatically set by the system 10, e.g., based on previous usage of the system 10 such as obtaining other assets. Of course, in some implementations of the system 10, this authentication step may be omitted entirely, such that all trackable assets are available to the first user.

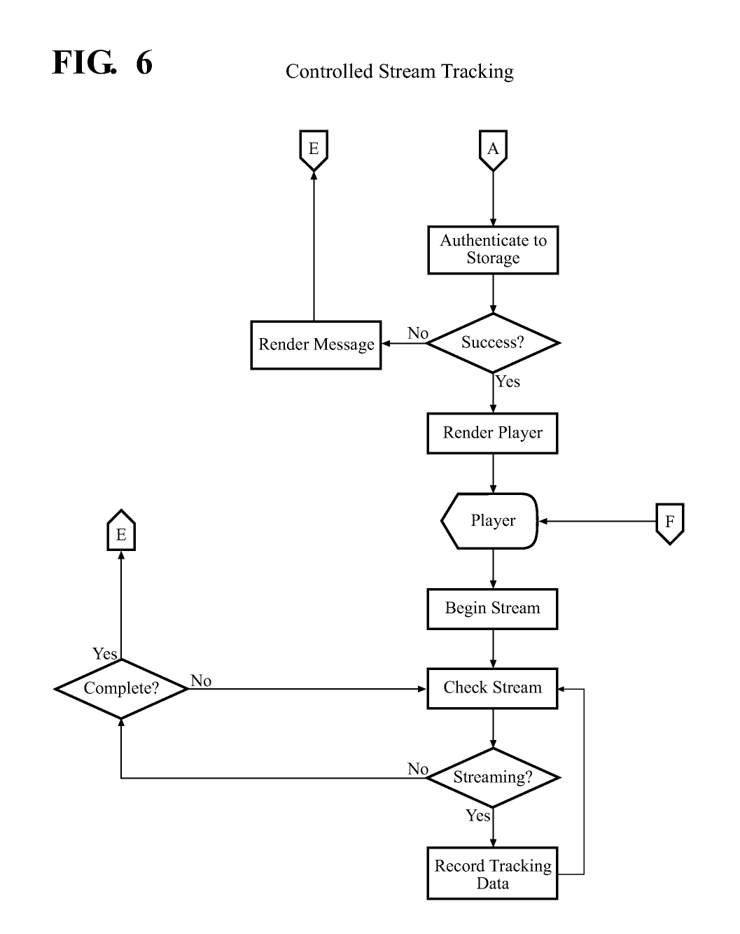

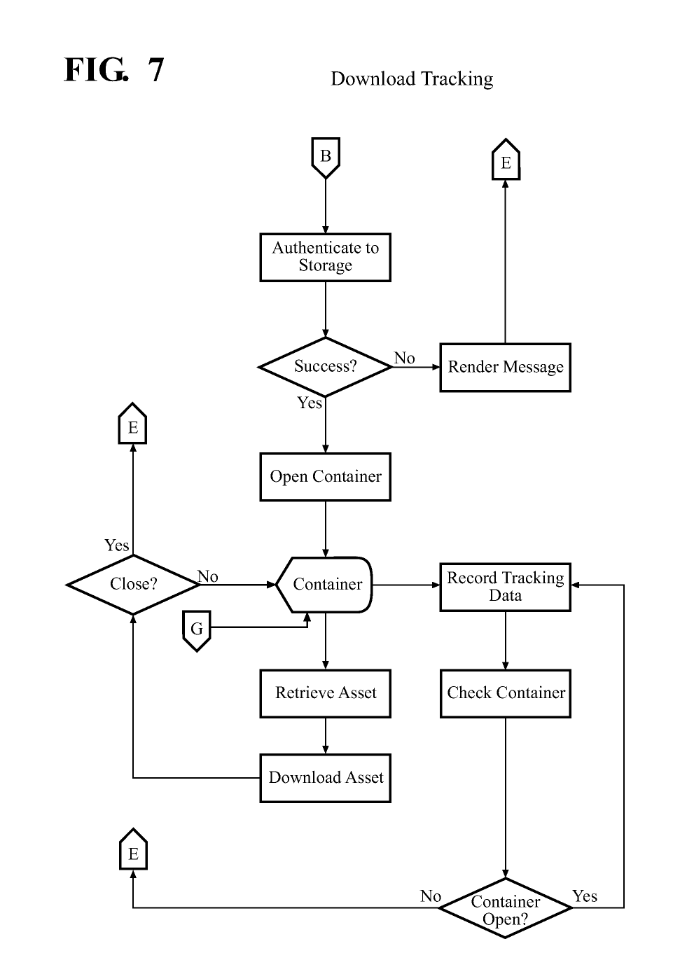

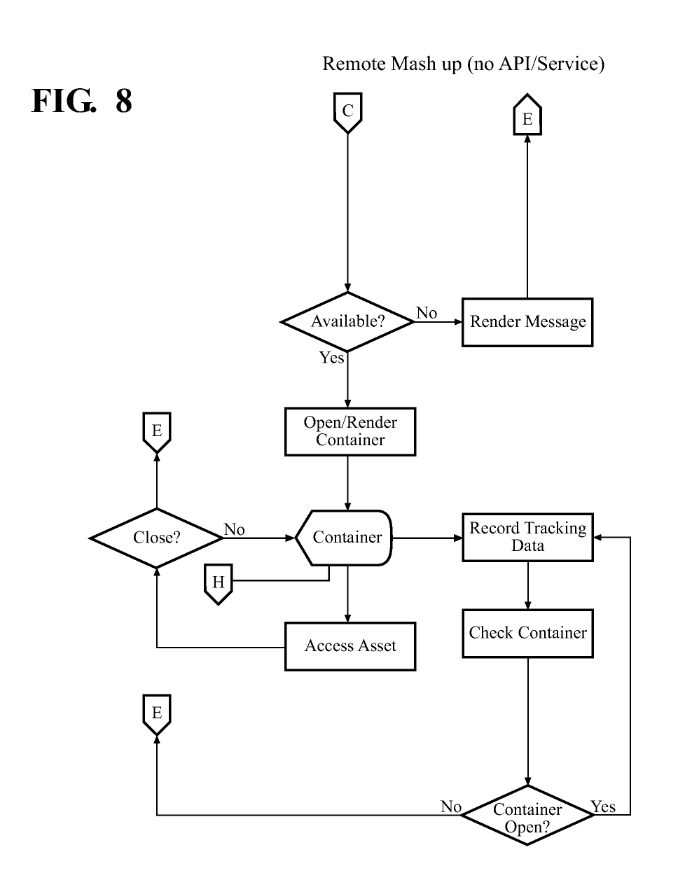

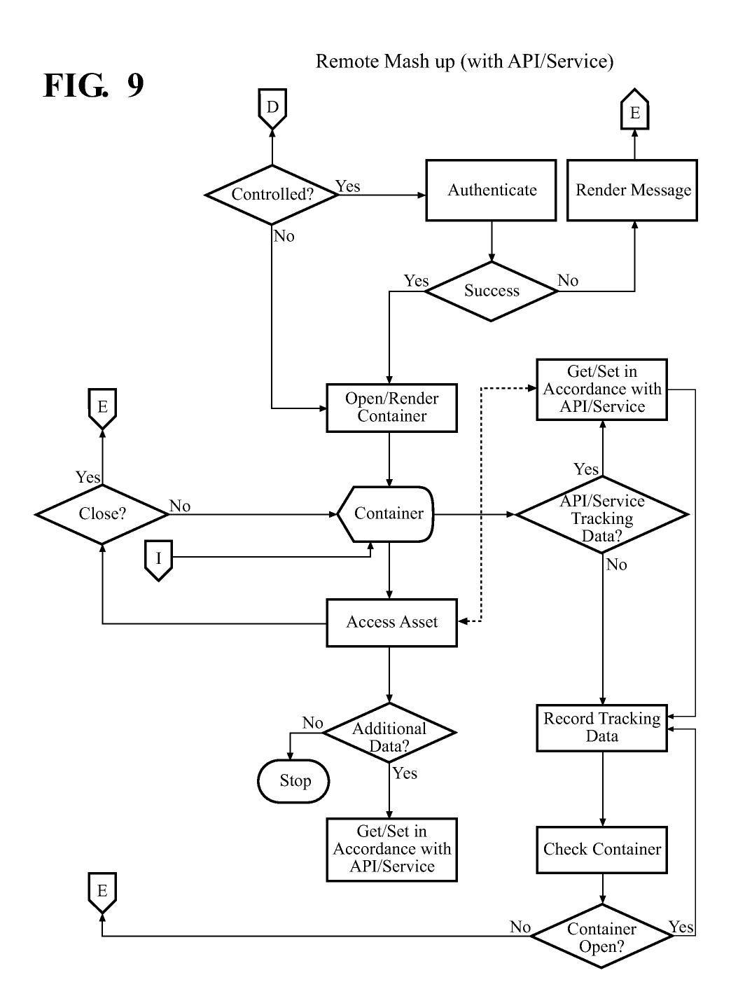

If the first user is not authorized to receive the requested trackable asset, then the system 10 may provide a suitable error message to the first user. However, if the first user is authorized to receive the requested trackable asset, the method further includes the step of delivering the trackable asset to the first user. Delivery of the trackable asset is necessarily predicated on the format of the asset. The illustrated embodiment presents four different formats for the asset: a controlled stream (e.g., a video or audio stream), a downloadable file (or “download”), a remote mash-up with an application program interface (“API”) or service, and a remote mash-up without an API or service. It is to be appreciated that the term “downloadable file”, as used herein, refers to a data file other than an audio and/or video stream. Those skilled in the art realize other technical similarities and differences between these formats and are therefore not presented in detail herein. Furthermore, those skilled in the art realize that other formats may also be utilized within the scope of the invention.

Where the format of the asset is a controlled stream, the system 10 renders a player at the first client computer 14, as shown in FIG. 6. Depending on the circumstances, the player may or may not contain controls which allow the first user to determine when the stream begins, pauses, stops, and so forth.

Where the format of the asset is a downloadable file or a remote mash-up (with or without the API or service), the system 10 opens a container (not numbered) on the first client computer 14, as is shown in FIGS. 7, 8, and 9. Those skilled in the art realize that a “container” refers to a class, a data structure, or an abstract data type that contain other data objects. In the illustrated embodiments, the container contains the downloadable file or the remote mash-up.

The method further includes the step of recording data regarding delivery of the trackable asset to the first user. Where the format of the asset is a controlled stream, the method includes checking whether or not the steam is playing at a plurality of predetermined intervals. That is, in the illustrated embodiment, the system 10 repeatedly queries whether or not the audio and/or video stream is being transmitted by the server computer 12 and received at the first client computer 14. This can be accomplished by monitoring receipt of the stream at the rendered player on the first client computer 14 or by other techniques. Similarly, where the format of the asset is a downloadable file or a remote mash-up, the system 10 repeatedly queries whether or not the container is open.

In addition to tracking whether or not the controlled stream is being transmitted and/or received and whether or not the container is open, the system 10 tracks other data. This other data includes, but is not limited to: a language and/or locale of the first client computer 14, an IP address of the first client computer 14, a MAC address of the first client computer 14, a browser type, a browser version, a security model, an application, an application module, context, date/time, tracking model, tracking source, view, an asset identification, a user identification, and other information about the state of the session.

In addition to the data that is directly tracked by the system 10, the system 10 may also derive data based on this directly tracked data. The derived data includes, but is not limited to: raw points per track, aged points aggregates, sequence identifier, relevance to known users, percentage of completion, and interaction behavior (play, rewind, advance, stop, replay, etc.).

Furthermore, supplemental data may be tracked when the asset being received is unknown. This supplemental data includes, but is not limited to: the unknown asset's relevance to a known asset; a shadow asset identifier; a uniform resource locator (URL) of the unknown asset; the type of player utilizing the unknown asset, if applicable; the file type of the unknown asset, if applicable; and a hypertext markup language (HTML) snippet.

It is important to note that the data being recorded and/or derived is accessible based on individual first users and individual sessions of receiving assets. As such, the data may be utilized to track the behavior of specific first users and how they relate with specific assets.

The method further includes the step of reporting the data to a second user. Preferably, the data is reported to the first user on a per asset basis for each first user. That is, a detailed log of the assets that each user has received may be perused, and acted upon, by the second user. More preferably, the data is reported in real-time. That is, data is provided to the second user as soon as possible after being gathered by the system 10. Advantages to providing the data in real-time are described in greater detail below.

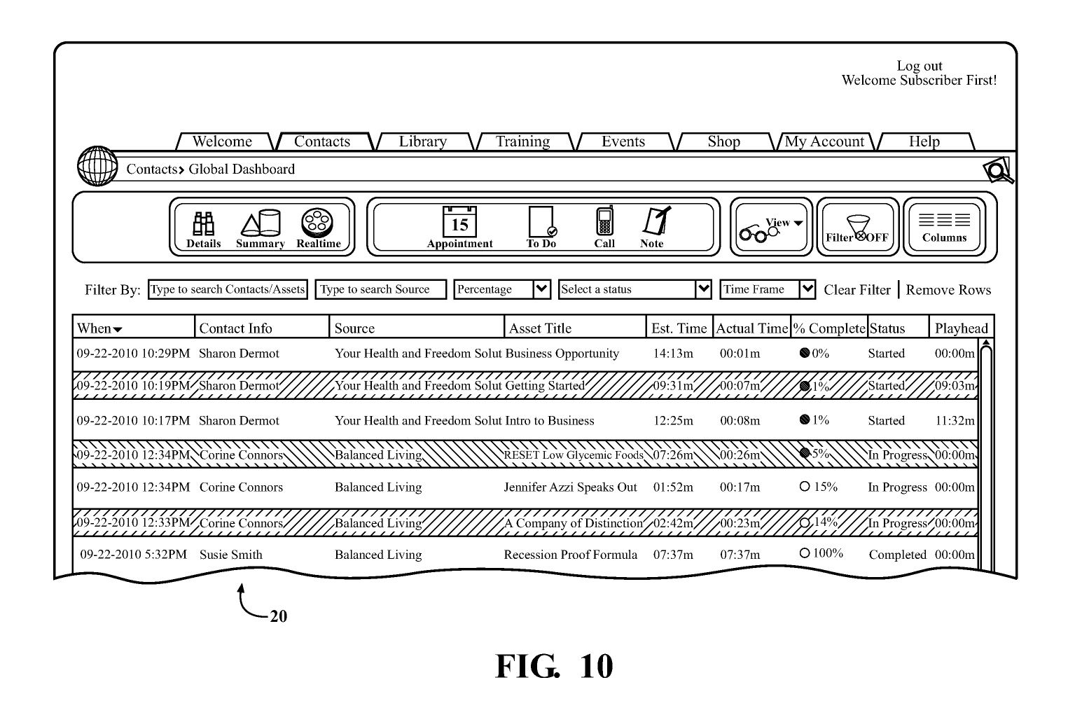

In the illustrated embodiment, the tracked data is concatenated and presented by a reporting application on a display 20 of the second client computer 16 to the second user, as is shown in FIG. 10. The second user then is able to view the collected data via the reporting application to show information such as, but not limited to: how long the first user viewed or interacted with an asset; what actions where taken by the first user (e.g., rewind, fast forward, button clicks, field entries, etc.); and how the first user arrived at the asset (e.g., whether the user viewed or interacted with the asset in a media library or a prospecting portal). The reporting application may also show the date/time of the latest tracking update, the name of the first user, a topic (or source location) of the asset, the name (or title) of the asset, the estimated time needed to fully receive the asset, the actual time of receiving, the completeness of the asset being received (e.g., actual time divided by estimated time), the current status of the asset (e.g., “started”, “in progress”, or “finished”), and a playhead time (which refers to the moment in time that a player was stopped or closed during the playback stream).

By providing the data to the second user in real-time, the system 10 and method enable the second user to quickly and intelligently react to the assets being received by the first user. For example, after the first user completes viewing a video teaching sales techniques, the second user may contact the first user to answer follow-up on the content presented in the video and to answer questions. In another example, if the second user observes that the first user did not finish watching a video, the second user may contact the first user to inquire as to why.

It may be desirous for the assets that are received by the first user to be presented in a certain order, or series, as part of a comprehensive program. As such, the system 10 and method may present the certain assets to the first user in a predetermined order. This may be accomplished, for example, by the system 10 controlling the permissions for each asset to prevent the first user from receiving one asset until another asset has been fully received. Furthermore, the reporting of asset delivery to the second user may show the various assets in a sequential order (not shown), such as a flowchart type diagram of assets.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A method of tracking and reporting user behavior to a user on a computerized system, said method comprising the steps of:
identifying a first user;
offering a trackable asset to the first user, wherein the trackable asset is receivable by the first user at a first client computer;
receiving a request to receive the trackable asset;
determining a type of asset that is requested;
authenticating whether or not the first user is authorized to receive the trackable asset;
delivering the trackable asset to the first client computer if the first user is authorized to receive the trackable asset;
recording data regarding delivery of the trackable asset to the first client computer; and
reporting the data to a second user.

2. A method as set forth in claim 1 wherein the trackable asset is a video stream and/or an audio stream.

3. A method as set forth in claim 2 wherein said step of recording data regarding delivery of the trackable asset to the first user includes the step of checking whether or not the video stream and/or audio stream is playing at a plurality of predetermined intervals.

4. A method as set forth in claim 3 further comprising the step of determining a length of time which the video stream and/or audio stream has been paused by the first user.

5. A method as set forth in claim 2 wherein said step of recording data includes recording the amount of data of the video stream and/or audio stream that has been received by the first client computer.

6. A method as set forth in claim 5 further comprising the step of calculating the fractional amount of the video stream and/or audio stream that has been received by the first user based on a total play time of the video stream and/or audio stream and the amount of data of the video stream and/or audio stream that has been received by the first client computer.

7. A method as set forth in claim 1 wherein the trackable asset is a downloadable file.

8. A method as set forth in claim 7 further comprising the step of opening a container and wherein said step of recording data regarding delivery of the trackable asset to the first user includes the step of checking whether or not the container is open at a plurality of predetermined intervals.

9. A method as set forth in claim 8 wherein said step of recording data includes recording the amount of data of the downloadable file that has been received by the first client computer.

10. A method as set forth in claim 9 further comprising the step of calculating the fractional amount of the downloadable file that has been received by the first user based on a total size of the downloadable file and the amount of data of the downloadable file that has been received by the first client computer.

11. A method as set forth in claim 1 wherein the trackable asset is further defined as a mash-up.

12. A method as set forth in claim 11 further comprising the step of opening a container and wherein said step of recording data regarding delivery of the trackable asset to the first user includes the step of checking whether or not the container is open at a plurality of predetermined intervals.

13. A method as set forth in claim 12 wherein said step of recording data includes recording the amount of data of the mash-up that has been received by the first client computer.

14. A method as set forth in claim 13 further comprising the step of calculating the fractional amount of the mash-up that has been received by the first user based on a total size of the mash-up and the amount of data of the mash-up that has been received by the first client computer.

15. A method as set forth in claim 1 wherein said step of receiving a request to receive the trackable asset is further defined as receiving a request to receive the trackable asset from the user.

16. A method as set forth in claim 1 wherein said step of reporting the data to a second user is done in real-time.

17. A method as set forth in claim 16 wherein said step of reporting the data to a second user includes the steps of sending the data to a second client computer in response to receiving the data being record and displaying the data on the second client computer.

18. A method as set forth in claim 1 wherein the trackable asset is information for facilitating the relationship building between a salesperson and a prospect.

19. A computerized system for tracking and reporting user behavior, said system comprising:
a first client computer;
a second client computer;
a server computer in communication with said client computers for identifying a first user using said first client computer, offering a trackable asset to the first user at the first client computer, wherein the trackable asset is receivable by the first user at said first client computer, receiving a request to receive the trackable asset, authenticating whether or not the first user is authorized to receive the trackable asset, delivering the trackable asset to the first user at said first client computer if the first user is authorized to receive the trackable asset, recording data regarding delivery of the trackable asset to the first user, and reporting the data to a second user at said second client computer.

20. A computerized system as set forth in claim 19 wherein said second client computer executes a reporting application for allowing the second user to view the recorded data regarding delivery of the trackable asset to the first user.

21. A computerized system as set forth in claim 19 wherein the trackable asset is a video stream and/or an audio stream.

22. A computerized system as set forth in claim 19 wherein the trackable asset is a downloadable file.

23. A computerized system as set forth in claim 19 wherein the trackable asset is further defined as a mash-up.

24. A computerized system as set forth in claim 19 wherein the reporting the data to a second user is done in real-time.
